(19) United States
(12) Patent Application Publication
(10) Pub. No.: US 2025/0352947 A1
(43) Pub. Date: Nov. 20, 2025

(54) Systems and Methods for Processing Flue Gas Carbon Dioxide

(71) Applicant: CleanO2 Carbon Capture Technologies Inc., Calgary (CA)

(72) Inventor: Jaeson Cardiff, Calgary (CA)

(21) Appl. No.: 18/866,295

(22) PCT Filed: May 19, 2023
(86) PCT No.: PCT/IB2023/000295

§ 371 Date: Nov. 15, 2024

Related U.S. Application Data
(60) Provisional application No. 63/344,379, filed on May 20, 2022.

(30) Foreign Application Priority Data
May 19, 2023 (WO) PCT/IB2023/000295

(51) Int. Cl. B01D 53/34; B01D 53/62

(52) U.S. Cl. CPC B01D 53/346; B01D 53/62; B01D 2257/504; B01D 2258/0283

(57) ABSTRACT

Embodiments include systems and methods for processing and capturing flue gas carbon dioxide. Improved systems for controlling flue gas processing equipment are described wherein sensors are used to both control carbon capture equipment and to monitor progress of a carbon capture reaction.

### CROSS-REFERENCE TO RELATED APPLICATIONS

This application claims priority to U.S. Provisional App. 63/344,379, titled “Systems and Methods for Processing Flue Gas Carbon Dioxide,” filed on May 20, 2022, and currently pending. The entire contents of U.S. Provisional App. 63/344,379 are incorporated herein by reference.

### FIELD

Examples described herein relate to systems and methods for controlling and monitoring flue gas processing equipment, with some examples involving processing and capturing flue gas carbon dioxide. Improved systems for controlling and monitoring flue gas processing equipment are described wherein sensors are used as part of the systems and methods for controlling carbon capture equipment and to monitor progress of a carbon capture reaction. Example systems and methods described provide improved operational efficiencies.

### BACKGROUND

In the past, systems for reacting chemicals, such as anhydrous metal hydroxides with carbon dioxide (CO₂) from a flue gas have been described. For example, systems for reacting flue gas with a metal hydroxide to capture carbon dioxide from flue gas are described U.S. application Ser. No. 15/928,741, titled “Flue Gas Carbon and Heat Capture and Recirculation System,” filed on Mar. 22, 2018, and issued as U.S. Pat. No. 10,537,851 on Jan. 21, 2020 (referred to herein as “Cardiff '851”). The entire contents of U.S. application Ser. No. 15/928,741 are incorporated herein by reference.

As described in Cardiff '851, waste flue gas may be obtained from a flue gas source, which may be a hydrocarbon fueled heating device/appliance, such as a boiler, furnace, or hot water heater. A portion of the waste flue gas, which has a high concentration of CO₂, can be introduced into a reactor containing a solid reactant such as an anhydrous metal hydroxide (e.g. sodium hydroxide or potassium hydroxide). In the reactor, CO₂ reacts with the solid reactant in an exothermic reaction to produce heat, water and a reaction product (e.g. a corresponding carbonate). The heat from the flue gas and reaction can be captured for re-use in another system, such as heating air and/or heating water for domestic, industrial or commercial use, and the reaction product is recovered as a useful by-product. In addition, a CO₂ depleted flue gas is also produced which reduces CO₂ emissions of the heating device/appliance to the atmosphere.

In a typical flue gas capture system (FGCS), and in the case of an anhydrous metal hydroxide being the reactant, upon exposure to the flue gas, the reaction to the corresponding carbonate will progress over time. The reaction will be affected by a number of operational and environmental factors.

Improvements in such systems and/or processes are desired.

### SUMMARY

It is an object of the present disclosure to obviate or mitigate at least one disadvantage of previous carbon capture and heat recovery systems.

In a first aspect, a system is described, the system comprising: a reactor having a flue gas inlet for connection to a flue gas source, a mixing system configured to mechanically agitate a solid reactant within the reactor, a gas outlet and a flue gas return system for connection to a flue; a fan configured to the gas outlet for drawing flue gas through and out of the reactor and to the flue gas return system, the fan operable at a fan speed; at least one flue gas parameter sensor configured to any one of or a combination of the flue gas inlet, flue gas source or flue; at least one processor configured to the at least one flue gas parameter sensor and to the fan; tangible, non-transitory computer-readable media comprising program instructions executable by the at least one processor such that the system is configured to: in response to at least one flue gas parameter threshold being exceeded, the processor increases fan speed and in response to at least one flue gas parameter threshold not being exceeded decreases fan speed.

In some embodiments, the at least one processor is configured to activate a standby mode and remain in the standby mode while the at least one flue gas parameter threshold has not been exceeded, and to maintain fan speed at a base fan speed in standby mode.

In some embodiments, the at least one processor is configured, in response to at least one flue gas parameter threshold being exceeded, to start a cumulative timer and to calculate a total cumulative time when the at least one flue gas parameter threshold is exceeded.

In some embodiments, the at least one processor is configured, in response to the total cumulative time exceeding a cumulative time threshold, to activate an agitation mode.

In some embodiments, the processor is configured, in response to activation of the agitation mode, to reset the cumulative timer to zero.

In some embodiments, the at least one processor is configured, in response to activation of the agitation mode, to start an agitation mode timer and to activate the mixing system.

In some embodiments, the at least one processor is configured, in response to activation of the agitation mode, to stop the fan.

In some embodiments, the at least one processor is configured, in response to the agitation mode timer exceeding an agitation mode time threshold, to stop the agitation system.

In some embodiments, the at least one processor is configured, in response to the agitation mode timer exceeding an agitation mode time threshold, to stop the agitation system and to run the fan at a base speed.

In some embodiments, the at least one processor is configured, in response to the agitation mode timer exceeding an agitation mode time threshold, to stop the agitation system and to run the fan at a base speed after a delay time.

In some embodiments, the at least one processor is configured, in response to the total cumulative time not exceeding a cumulative time threshold, to activate a reaction management mode.

In some embodiments, the system further comprises at least one reaction parameter sensor configured to the reactor and wherein the at least one processor is configured, in response to activation of the reaction management mode, to determine if at least one reaction parameter is exceeded, and if exceeded to increase fan speed.

In some embodiments, the at least one processor is configured, in response to activation of the reaction management mode, to determine if at least one reaction parameter is not exceeded, and if not exceeded to decrease fan speed.

In some embodiments, the at least one flue gas parameter sensor includes a temperature sensor.

In some embodiments, the at least one flue gas parameter sensor includes a carbon dioxide concentration sensor.

In some embodiments, the at least one reaction parameter sensor includes a humidity sensor.

In some embodiments, the processor is configured to control fan speed based on a linear correlation to an absolute humidity measurement between a low humidity threshold and a high humidity threshold and where low fan speed is correlated to a lower absolute humidity measurement.

In some embodiments, the processor is configured to control fan speed based on a non-linear correlation to an absolute humidity measurement between a low humidity threshold and a high humidity threshold and where a higher absolute humidity measurement results in a proportionally higher fan speed.

In some embodiments, the at least one reaction parameter sensor includes a viscosity sensor.

In some embodiments, the at least one processor is configured to start a standby timer in standby mode and wherein if a standby timer threshold is exceeded, to enter an agitation mode.

In some embodiments, the system further comprises at least one network interface configured to the at least one processor and wherein the at least one network interface and the at least one processor are configured to report sensor data to a central computer system over at least one network and to receive instructions from the central computer system.

In some embodiment, the system further comprises an image capture system configured to the at least one processor for capturing image data of the system.

In some embodiments, the system further comprises a sound capture system configured to the at least one processor for capturing sound data of the system.

In some embodiments, the system further comprises a movement capture system configured to the at least one processor for capturing movement data of the system.

In some embodiments, the system further comprises a user interface configured to the at least one processor to display system data to a user and to enable a user to enter data.

In another aspect, a method of controlling a flue gas capture system is described, the method comprising the steps of: in a flue gas capture system having at least one processor operable in a standby mode, tangible, non-transitory computer-readable media comprising program instructions executable by the at least one processor, a mixing system, a fan and at least one flue gas parameter sensor configured to a flue gas source; in response to a flue gas parameter threshold being exceeded, increasing fan speed; and, in response to at least one flue gas parameter threshold not being exceeded, decreasing fan speed.

In some embodiments, the method further comprises the step of maintaining a base fan speed when the at least one processor is operating in the standby mode.

In some embodiments, when at least one flue gas parameter threshold is exceeded, the method further comprises the step of starting a cumulative timer and calculating a total cumulative time when the at least one flue gas parameter threshold is exceeded.

In some embodiments, when in response to the total cumulative time exceeding a cumulative time threshold, the method further comprises the step of activating an agitation mode.

In some embodiments, when in response to activation of the agitation mode, the method further comprises the step of resetting the cumulative timer to zero.

In some embodiments, when in response to activation of the agitation mode, the method further comprises the step of starting an agitation mode timer and activating the mixing system.

In some embodiments, when in response to activation of the agitation mode, the method further comprises the step of stopping the fan.

In some embodiments, when in response to the agitation mode timer exceeding an agitation mode time threshold, the method further comprises the step of stopping the agitation system.

In some embodiments, when in response to the agitation mode timer exceeding an agitation mode time threshold, the method further comprises the step of stopping the agitation system and running the fan at a base speed.

In some embodiments, when in response to the agitation mode timer exceeding an agitation mode time threshold, the method further comprises the step of stopping the agitation system and running the fan at a base speed after a delay time.

In some embodiments, when in response to the total cumulative time not exceeding a cumulative time threshold, the method further comprises the step of activating a reaction management mode.

In some embodiments, the flue gas capture system further comprises at least one reaction parameter sensor configured to the reactor and when, in response to activation of the reaction management mode, the method further comprises the step of: if at least one reaction parameter is exceeded, increasing fan speed.

In some embodiments, when in response to activation of the reaction management mode, the method further comprises the step of determining if at least one reaction parameter is not exceeded, and if not exceeded decreasing fan speed.

In some embodiments, the at least one flue gas parameter sensor includes a temperature sensor, and the method further comprises the step of monitoring flue gas temperature.

In some embodiments, the at least one flue gas parameter sensor includes a carbon dioxide concentration sensor, the method further comprises the step of monitoring flue gas carbon dioxide concentration.

In some embodiments, the at least one reaction parameter sensor includes a humidity sensor, the method further comprises the step of monitoring flue gas humidity.

In some embodiments, the at least one reaction parameter sensor includes a viscosity sensor, and the method further comprises the step of monitoring reactant viscosity.

In some embodiments, the processor is configured to start a standby timer in standby mode and, if a standby timer threshold is exceeded, the method further comprises the step of entering an agitation mode.

In another aspect, a system is described comprising: a reaction chamber comprising (a) a gas inlet coupled to a gas source and (b) a gas outlet; a sensor coupled to the gas source; a fan coupled to the gas outlet, the fan operable at at least a first fan speed and a second fan speed, the second fan speed greater than the first fan speed; at least one processor; and tangible, non-transitory computer-readable media comprising program instructions executable by the at least one processor such that the system is configured to: while the fan is operating at the first fan speed, receive, via the sensor, a parameter signal indicating a parameter corresponding to the gas source; determine, based on the received parameter signal, that the parameter corresponding to the gas source is above a parameter-threshold level; and based on the determination that the parameter is above the parameter-threshold level, cause the fan to transition from operating at the first fan speed to operating at the second fan speed.

In some embodiments, the sensor is a first sensor, and the system further comprises a second sensor, and wherein the program instructions executable by the at least one processor comprise further program instructions executable by the at least one processor such that the system is further configured to: while the fan is operating at the second fan speed, receive, via the second sensor, a humidity signal indicating a humidity level corresponding to the reaction chamber; determine, based on the received humidity signal, that the humidity level corresponding to the reaction chamber is above a humidity-threshold level; and, based on the determination that the humidity level is above the humidity-threshold level, cause the fan to transition from operating at the second fan speed to operating at a third fan speed, wherein the third fan speed is greater than the second fan speed.

In some embodiments, the humidity signal is a first humidity signal, and wherein the program instructions executable by the at least one processor comprise further program instructions executable by the at least one processor such that the system is further configured to: while the fan is operating at the third fan speed, receive, via the second sensor, a second humidity signal; determine, based on the received second humidity signal, that the humidity level corresponding to the reaction chamber is below the humidity-threshold level; and based on the determination that the humidity level is below the humidity-threshold level, cause the fan to transition from operating at the third fan speed to operating at a fourth fan speed, wherein the fourth fan speed is less than the third fan speed.

In some embodiments, the fourth fan speed is the same as the second fan speed.

In some embodiments, the system further comprises an agitation system, wherein the program instructions executable by the at least one processor comprise further program instructions executable by the at least one processor such that the system is further configured to: after causing the fan to transition from operating at the first fan speed to operating at the second fan speed, (a) cause the fan to stop and (b) activate the agitation system.

In some embodiments, activating the agitation system comprises activating at least one motor of the agitation system, wherein the at least one motor is configured to drive at least one stirring paddle.

In some embodiments, the program instructions executable by the at least one processor comprise further program instructions executable by the at least one processor such that the system is further configured to: before causing the fan to stop and activating the agitation system, determine that a cumulative operational time has elapsed since causing the fan to transition from operating at the first fan speed to operating at the second fan speed; and, determine that the determined cumulative operational time is greater than a cumulative operational time threshold.

In some embodiments, the program instructions executable by the at least one processor comprise further program instructions executable by the at least one processor such that the system is further configured to: after causing the fan to stop and activating the agitation system, determine that a cumulative agitation time has elapsed since activating the agitation system; determine that the determined cumulative agitation time is greater than a cumulative agitation time threshold; and after determining that the determined cumulative agitation time is greater than the cumulative agitation time threshold, deactivate the agitation system.

In some embodiments, the sensor is a first sensor, the system further comprising a second sensor, and wherein the program instructions executable by the at least one processor comprise further program instructions executable by the at least one processor such that the system is further configured to: before determining that the parameter corresponding to the gas source is above the parameter-threshold level, receive, via the second sensor, a humidity signal indicating a humidity level corresponding to the reaction chamber; determine, based on the received humidity signal, that the humidity level corresponding to the reaction chamber is above a humidity-threshold level; and, based on the determination that the humidity level is above the humidity-threshold level, cause the fan to transition from operating at the first fan speed to operating at a second fan speed, wherein the second fan speed is greater than the first fan speed.

In some embodiments, the system further comprises at least one network interface, and wherein the program instructions executable by the at least one processor comprise further program instructions executable by the at least one processor such that the system is further configured to: before the fan operates at the first fan speed, receive, via the network interface over at least one wide area network (WAN), an indication of the first fan speed.

In some embodiments, the system further comprises at least one user interface, and wherein the program instructions executable by the at least one processor comprise further program instructions executable by the at least one processor such that the system is further configured to: before the fan operates at the first fan speed, receive, via the at least one user interface, an indication of the first fan speed.

In some embodiments, the system further comprises at least one network interface, and wherein the program instructions executable by the at least one processor comprise further program instructions executable by the at least one processor such that the system is further configured to: while the fan is operating at the first fan speed, transmit, via the network interface over at least one wide area network (WAN) to a computing system, an indication of the first fan speed.

In some embodiments, the system further comprises at least one network interface, and wherein the program instructions executable by the at least one processor comprise further program instructions executable by the at least one processor such that the system is further configured to: after causing the fan to transition from operating at the first fan speed to operating at the second fan speed, transmit, via the network interface over the at least one WAN to the computing system, an indication of the second fan speed.

In some embodiments, the system further comprises at least one network interface, and wherein the program instructions executable by the at least one processor comprise further program instructions executable by the at least one processor such that the system is further configured to: after receiving the parameter signal indicating a parameter corresponding to the gas source, transmit, via the network interface over at least one wide area network (WAN) to a computing system, the indication of the parameter corresponding to the gas source.

In some embodiments, the sensor comprises a temperature sensor, and wherein the parameter corresponding to the gas source comprises a temperature corresponding to the gas source.

In some embodiments, the sensor coupled to the gas source comprises the sensor coupled to at least one of (a) a flue gas source equipment, (b) a flue, and (c) a bypass flue.

### BRIEF DESCRIPTION OF THE DRAWINGS

Various objects, features and advantages will be apparent from the following description of particular embodiments, as illustrated in the accompanying drawings. The drawings are not necessarily to scale, emphasis instead being placed upon illustrating the principles of various embodiments. Similar reference numerals indicate similar components.

FIG. 1 depicts a schematic diagram of an example flue gas capture system (FGCS) 100 shown in a representative operating environment and being configured to flue gas source equipment and a flue.

FIG. 2 depicts a schematic block diagram of an example FGCS 200 including some example components of the example FGCS in accordance with some embodiments.

FIG. 3 depicts a schematic diagram showing an example communications system and network of a FGCS 300 in accordance with some embodiments.

FIG. 4 depicts a diagram of an example processor 400 and various inputs in accordance with some embodiments.

FIG. 5 depicts a flowchart illustrating an example control scheme 500 for a FGCS in accordance with some embodiments showing multiple modes of operation.

FIG. 6 depicts a flowchart illustrating an example control scheme 600 for controlling fan speed within a FGCS in accordance with some embodiments.

FIG. 7 depicts a flowchart illustrating an example control scheme 700 for controlling fan speed based on measured humidity within a FGCS in accordance with some embodiments.

FIG. 8 depicts a flowchart illustrating an example control scheme 800 for entering an operation mode and an agitation mode of a FGCS in accordance with some embodiments.

FIG. 9 depicts a flowchart illustrating an example control scheme 900 for controlling fan speed based on measuring ambient humidity as a method of determining a threshold for FGCS control in accordance with some embodiments.

### DETAILED DESCRIPTION

### Overview

There is a need for systems and methods that improve the operation of a flue gas capture system (FGCS).

As discussed herein, a variety of operational and environmental variables may impact the efficiency and/or general progress of the reactions within a FGCS. It is therefore desirable to design the FGCS and/or the monitoring/control system of a FGCS so that those variables are managed in such a way that improves the overall efficiency of the operation of the FGCS including functions involving the capture of carbon dioxide from flue gas, heat recovered from FGCS and the quality of product obtained from the FGCS.

One consideration related to the operation of a FGCS is that a FGCS is desirably operated without affecting the operation of flue gas source equipment (e.g. a boiler or furnace).

Another consideration is the quality of the product obtained from the FGCS, including the consistency and moisture content of the product.

Having regard to the above, another consideration is that the timing of flue gas source equipment operation is intermittent, which results in an intermittent supply of flue gas to the FGCS which can directly impact conditions within the FGCS equipment that can affect the reaction kinetics, the consistency of reactants and ultimately the quality of reaction products. That is, the irregular (i.e. on/off and variable heat) operation of connected flue gas source equipment means that there is a high variation in temperatures, pressures, flow rates, and carbon dioxide concentration over time. It is desirable that some or each of these variables are directly or indirectly monitored and that the FGCS equipment respond to changes in these variables so as to enable the reactions and overall process(es) to occur efficiently, to mitigate problems, and to help ensure that the reactions produce a high-quality product.

While the FGCS as described in Cardiff '851 is effective, as noted above, the operation of the FGCS is dependent on the source equipment and its intermittent operation which can result in various operational problems in running and controlling the FGCS equipment to obtain a high-quality product. Ultimately, variations in flue gas parameters which include any or all of temperature, pressure, heat, flow rate, and carbon dioxide concentration of a flue gas can result in various operational inefficiencies including a lower-quality product (e.g. a carbonate with clumps) and/or requiring involvement of personnel to ensure ongoing operation of the FGCS.

Given these variations, one problem is that the extent and/or state of the reaction of the flue gas with solid reactants is not precisely known and/or accounted for during FGCS operation. Other environmental variables including ambient humidity may also affect the reactions.

That is, as flue gas source equipment turns on and off, the conversion reactions between the flue gas and solid reactant similarly start and stop (and may increase and decrease in rate) based on the availability of the flue gas which also results in variations in the physical states of the reactants at different times. Specifically, as the reaction of an anhydrous metal hydroxide with CO₂ produces water, the produced water combines with the solid reactants in the FGCS. Over the course of the reaction, an initially solid anhydrous metal hydroxide can transform to a viscous semi-solid/liquid aqueous mixture, then potentially into a full liquid and then back to a dry solid carbonate upon completion of the reaction. Such variations in the state of the reaction and/or other conditions related to the reaction may be referred to as reaction parameters. Reaction parameters may be direct or indirect measurements of conditions within a reactor that may provide an indication of the state/status of a particular reaction at a particular instance in time. For example, a direct measurement may be measurement of viscosity of reactants and/or temperatures of the reactants whereas an example of an indirect measurement may be measurement of humidity within the reaction chamber.

Changing consistency of the reactants can affect the rate of reaction and material handling. For example, viscous intermediate mixtures reduce available surface area for contact with flue gas with the result being that the reaction slows. Moreover, viscous mixtures can also be difficult to handle. Further, if not properly managed, a viscous mixture, when exposed to heat can dry out and become a solid block within the reactor that will potentially ruin a given batch, risk serious damage to the FGCS, and/or require considerable efforts by personnel to remove.

Agitation of the mixture can desirably be used to help address the surface area and handling issue. However, agitation can potentially and undesirably result in an amount of reactant being lost as the reaction proceeds, because if the reactants are in a fine-powdered state, agitation may cause excess reactant to become airborne. This can result in reactant being displaced into the path of flue gas flow within the reactor and then carried away from the reactor with the flue gas into the main flue and lost to the atmosphere. While various filters can be incorporated into the FGCS, filters are prone to clogging which can have an undesired effect on the operation of the flue gas source equipment and/or the FGCS. Hence, there is a need for systems that can react to the potentially irregular operation of the source equipment while minimizing a loss of reactants and filter clogging.

Other problems are ensuring that operation of the FGCS does not adversely affect the operation of the source equipment and that the FGCS is only operated under conditions that do not affect the operation of the source equipment.

Specifically, there is a need for systems and processing methods wherein flue gas parameters, such as temperatures of flue gas from the source equipment are monitored for directing flue gas to the FGCS when favorable conditions such as temperatures and CO₂ concentrations are available for operation of the FGCS. For example, it may be desirable to operate the FGCS when the source equipment is on and generating CO₂ and/or the temperature of flue gas within the flue is above a threshold temperature. Further, it is noted that flue gas temperature may be a proxy for sufficient CO₂ concentration and available heat for moisture management. It may also be desirable to manage heat (e.g. reaction heat) within the FGCS to optimize recovered heat from an associated heat exchanger.

Another problem is managing reaction parameters such as, for example, moisture/humidity/viscosity within the FGCS and operating the FGCS to maintain for example favorable moisture/humidity conditions. As noted above, the consistency of a solid reactant may vary during operation of the FGCS as a result of heat from the flue gas, and the heat and water generated from the reactions which can collectively result in variations in the humidity within the FGCS. For example, if the reaction conditions have been such that the reactant within the FGCS has become “wet” and the consistency of the reactant has changed to a viscous liquid, removing moisture from the FGCS is desired to transform the liquid reactant to a dry powder. Hence, there is a need for systems and methods wherein reaction parameters such as, for example, moisture/humidity/viscosity within the FGCS are monitored as an input to control operation of the FGCS in order to manage the consistency of the solid reactant, the progression of reactions, reactant processing and handling within the FGCS and to desirably control the quality of product.

### FGCS, Source Equipment and Operation

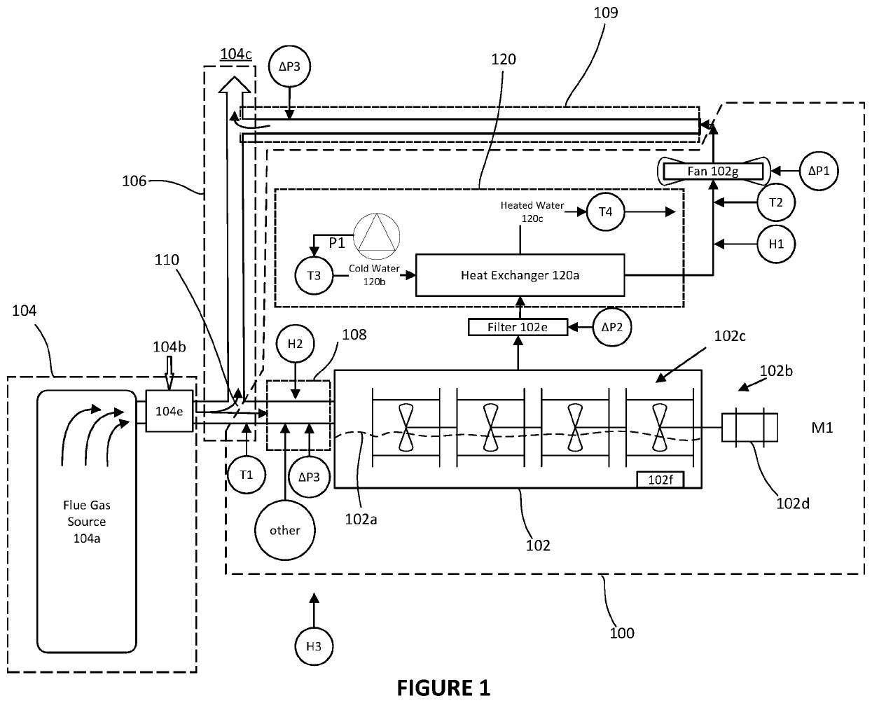

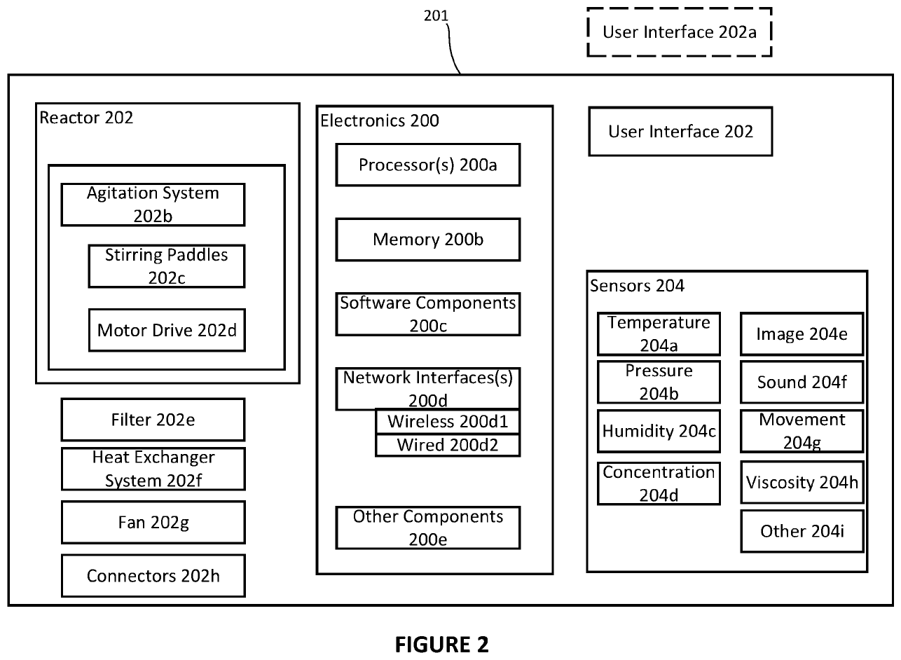

In the Figures, identical reference numbers identify generally similar, and/or identical, elements. To facilitate the discussion of any particular element, the most significant digit or digits of a reference number refers to the Figure in which that element is first introduced. For example, element 100 is first introduced and discussed with reference to FIG. 1 and element 200 is first introduced and discussed with reference to FIG. 2.

Many of the details, dimensions, angles and other features shown in the Figures are merely illustrative of particular embodiments or examples of the disclosed technology. Accordingly, other embodiments can have other components, details, dimensions, angles and features without departing from the spirit or scope of the disclosure. In addition, those of ordinary skill in the art will appreciate that further embodiments of the various disclosed technologies can be practiced with described components or details combined and/or arranged in other manners or orders, with additional components or details, and/or without several of the components and/or details described below.

FIG. 1 depicts an example operating environment including an example FGCS 100 connected to flue gas source equipment 104 (also referred to herein as “source equipment”). While FIG. 1 illustrates a representative operating environment, it is understood that aspects of the described operating environment, including aspects of each of the source equipment and/or other details of the environment in which a FGCS is operated, may be quite different.

For example, flue gas source equipment 104 may have wide variations in various parameters including, for example, maximum and average thermal output, flue gas flow rates under different operating conditions, wide variations in cycle times that the equipment is operating and/or the time between cycles and the size, height, and flow rates of associated flues.

A FGCS may be configured to operate with various categories of flue gas source equipment including non-condensing gas fired appliances such as category 1 and category 3 appliances. A category 1 appliance can be defined as an appliance that operates with a nonpositive vent static pressure and with a vent gas temperature that avoids excessive condensate production in the vent whereas a category 3 can be defined as an appliance that operates with a positive vent static pressure and with a vent gas temperature that avoids excessive condensate production in the vent. An FGCS can also work with other categories of gas fired appliances including cogeneration and combined heat and power systems, or any gas fired appliance that operates under non-condensing conditions. In one example, a FGCS may be operated on appliances that have a minimum 4-inch vent and can have a venting system pressure differential that is not impacted by more or less than 0.02 inches of water column.

Environments, buildings, and/or mechanical rooms where source equipment is configured and/or installed may have wide ranges of environmental parameters potentially affecting source equipment operation including, for example, temperature ranges and humidity ranges. Such conditions can also vary seasonally.

Further, the size and capacity of a FGCS 100 can vary, perhaps based on the operating parameters of source equipment and the environmental parameters as described herein.

With reference to FIG. 1, a FGCS 100, flue gas source equipment 104, flue 106, flue gas bypass system 108 and flue gas return system 109 are shown. Each are depicted as comprising multiple components as shown within dotted lines for general description. It is understood that the illustrated components of each system may be varied as described herein and understood by those skilled in the art.

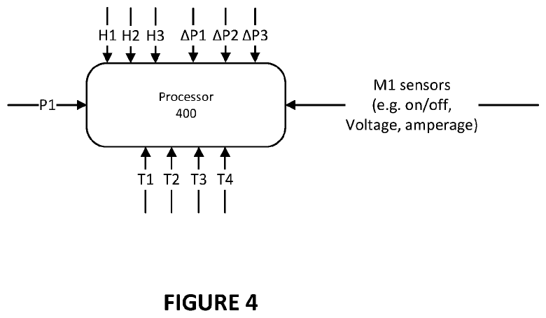

The FGCS 100 reacts flue gas comprising CO₂, heat and water vapor with a metal hydroxide in a reactor 102 connected to the flue gas source equipment 104. The flue gas source equipment 104 may be, for example, a furnace or water heater/boiler (among other possible examples) having a burner that combusts natural gas to produce heat for heating air or water. The combustion products from the source equipment, that is a “flue gas”, are carried from the source equipment via flue 106 and vented (e.g. to atmosphere 104c). As similarly described in Cardiff '851, incorporated herein by reference (see for example FIGS. 1 and 4 of Cardiff '851 and corresponding description), the FGCS 100 is configured to the flue 106 via a bypass flue 108 enabling at least a portion 110 of the flue gas from the source equipment to be diverted from the flue 106 to enter the FGCS 100. Flue gas from the FGCS 100 is returned to the flue 106 via downstream flue gas return system 109.

The source equipment 104, for example, may include a flue gas source 104a (e.g. a gas-fueled burner) and a draft hood 104e connected to the source equipment 104. The draft hood 104e introduces additional air 104b into the flue 106 to promote a desired draft within the flue 106.

FGCS 100 may include numerous components, including as selected examples and as depicted in FIG. 1, a reactor 102 for containing solid reactant 102a, an agitation system 102b having one or more stirring paddles 102c, a motor drive 102d operable to drive the stirring paddle(s) 102c, filter 102e, heat exchanger system 120, and a fan 102g.

Heat exchanger system 120 may include a gas/liquid heat exchanger 120a (e.g. a shell and tube heat exchanger) with an associated cold-water supply 120b, pump P1 and warm water output 120c.

A further depiction of an example FGCS 201 is shown in FIG. 2. FGCS 201 may be generally understood to be similar and/or the same as FGCS 100 shown in FIG. 1, with different or similar respective aspects depicted explicitly in each representation. As such, FIG. 2 depicts some components shown in connection with FIG. 1, as well as additional example components of an example FGCS, as part of a representative schematic of FGCS 201.

### Reactor

As shown in FIG. 2, the FGCS 201 includes a reactor 202, having an agitation system 202b, stirring paddles 202c and one or more motor drives 202d, filter 202e, heat exchanger system 202f, fan 202g and connectors 202h for attaching FGCS to other components and/or equipment such as the source equipment.

### Electronics

The FGCS 201 may include additional and/or alternative components including electronics 200, including processor(s) 200a, memory 200b, software components 200c, network interface(s) 200d (e.g. wireless interface 200d1 and/or wired interface 200d2) and other components 200e.

The electronics 200 can be configured to receive signals from user interfaces 202, 202a and/or sensors 204, among other potential sources of signals, process those signals, and then ultimately control FGCS 201 including any of its individual components. Collectively, the electronics 200 and associated sensors 204 may be referred to herein as a monitoring system. In some examples, such a monitoring system may include components in addition to electronics 200 and sensors 204.

In some examples, the electronics 200 optionally include one or more other components 200e (e.g., power supply, one or more sensors (in addition to sensors 204), video displays, touchscreens, etc.).

### Processors

The processor(s) 200a can comprise clock-driven computing component(s) configured to process data, and the memory 200b can comprise a computer-readable medium (e.g., a tangible, non-transitory computer-readable medium, data storage loaded with one or more of the software components 200c) configured to store instructions for performing various operations and/or functions. The processor(s) 200a are configured to execute the instructions stored on the memory 200b to perform one or more of the operations. The operations can include, for example, causing the FGCS to transition between various operating modes such as “off,” “on,” and/or “standby” among other modes. Such operations might also include, for example, causing the speed of fan 202g to change based on one or more signals received from one or more sensors 204. Other examples of such operations exist, some of which are described below.

### Memory

In some examples, the memory 200b is further configured to store data associated with the FGCS 201, such as various operational characteristics such as device version information, installation location, and/or other information regarding the broader operating environment in which it is installed. The stored data can comprise one or more state variables that are periodically updated and used to describe a state of the FGCS 201. The memory 200b can also include data associated with a state of one or more of the other devices (e.g., flue gas source equipment 104 depicted in FIG. 1) and/or other data relevant to the operating environment (e.g. temperature, weather data (predicted or current) etc.). Such data associated with the state of other devices might, in an example, be received via one or more of sensors 204 and/or one or more network interface(s) 200d.

### Software Components

The electronics may be configured with operational software stored in memory 200b and executable by processor 200a to effect operation of the FGCS 201 in the various operational modes described herein.

### Communications/Network Interface

In one embodiment, a FGCS 201 has one or more network interfaces 200d. The network interface 200d is generally configured to facilitate a transmission and receipt of data between the FGCS 201 and one or more other devices on a data network such as, for example, a local area network (LAN) and/or a wide area network (WAN), among other examples of networks.

In an example, the network interface(s) 200d is configured to transmit and receive data corresponding to signals (e.g., non-transitory signals) comprising digital packet data including an Internet Protocol (IP)-based source address and/or an IP-based destination address. The network interface(s) 200d can parse the digital packet data such that the FGCS electronics properly receives and processes the data destined for the FGCS 201.

The network interface(s) 200d may comprise one or more wireless interfaces 200d1. Such a wireless interface (e.g., a suitable interface comprising one or more antennae) can be configured to wirelessly communicate with one or more other devices (e.g. device 202a) that are communicatively coupled via a network in accordance with a suitable wireless communication protocol (e.g., NFC, WiFi, Bluetooth, Wireless Direct, other proprietary wireless protocol, LTE, or any such wireless standard corresponding to e.g. IEEE 802.11a, 802.11b, 802.11c, 802.11g, 802.11n, 802.11ac, 802.15, 4G mobile communication standard and/or other networking systems and protocols to enable one-way or two-way communication with a central computer system). In some embodiments, the network interface(s) 200d includes a wired interface 200d2 (e.g., an interface or receptacle configured to receive a network cable such as an Ethernet, a USB-A, USB-C, and/or Thunderbolt cable) configured to communicate over a wired connection with other devices in accordance with a suitable wired communication protocol. In certain embodiments, the network interface(s) 200d includes a wired interface and excludes a wireless interface. In some examples, the FGCS 201 excludes the network interface(s) 200d altogether and transmits and receives media content and/or other data via another communication path.

### User Interface(s)

In various embodiments, the user interface(s) 202, 202a can include one or more buttons, knobs, dials, touch-sensitive surfaces, displays, and/or touchscreens allowing user(s) to interface with the FGCS 201 via a wired or wireless connection and/or with one or more computer systems within a connected computer network. User interaction through interface(s) 202, 202a may provide input control data to the FGCS for commissioning, maintenance, reporting, control and the like and/or to receive/send data to/from one or more computer systems (e.g. a central computer system) as described herein.

### Sensors

FGCS 201 may include sensors 204 such as, for example, temperature 204a, pressure 204b, humidity 204c, concentration 204d, image capture 204e (e.g. a camera), sound 204f (e.g. a microphone), movement 204g (e.g. an accelerometer), viscosity 204h and other sensors 204i. Sensors may be applied to different locations of the FGCS, the source equipment, connectors and/or other locations.

For example, various sensors and sensor pairs may be configured to the FGCS to enable operation of the FGCS as described herein and to obtain data for the monitoring system to the control of the FGCS.

As shown in FIG. 1, various sensors may include any one or more (or all) of:
One or more humidity sensors; for example, a humidity sensor H2 configured to flue bypass 108 to measure humidity of flue gas at the exit of the source equipment. H2 may be coupled/compared to humidity sensor H1 to provide a humidity difference measurement which may be beneficial to improve control of the system particularly if the system is being run in humid environments and draft hood air is humid. The FGCS may also include H3 external to the equipment to measure ambient humidity.
One or more pressure sensors and pressure sensor pairs. Pressure sensors may be configured in various locations to measure absolute pressure or pressure differences across different areas of the system. For example, pressure sensor pairs may be placed across the fan (e.g. ΔP1), the filter (e.g. ΔP2) and/or the entire bypass piping (e.g. ΔP3).
One or more temperature sensors and temperature sensor pairs. Temperature sensors may be configured across the heat exchanger (e.g. T3 and T4) to control pump P1 and the flow of cool/cold water into the heat exchanger. Temperature sensor T2 may be configured to exit piping near the fan and be paired with T1 to measure a temperature difference across the FGCS during operation.
Carbon dioxide sensors (e.g. “concentration” 204d or “other” 204i in FIG. 2) may be configured, for example, to the flue and/or flue bypass to determine when to activate the FGCS and increase the flow of carbon dioxide into the FGCS.
Motor power (e.g. current and/or voltage) sensors 204h may be configured to the agitation system to monitor the relative viscosity of the reactants. For example, as the reaction progresses, and the reactant becomes more viscous, greater electrical power into the motor will be required to agitate the viscous mixture within the chamber. Similarly, as the reactants dry and become “spent”, the viscosity will reduce, and less power will be required to maintain a fixed agitation speed.

The sensors 204 are connected to processor(s) 200a via appropriate connections which may be wired or wireless.

Threshold parameters for each of the sensors or sensor pairs may be pre-configured by a manufacturer or configured based on the normal operating conditions at a particular installation and may be set-points manually entered by installation personnel, by input from other sensors and/or via a connected computer system. Some thresholds as described herein may be determined by differences between two similar sensors (e.g. a temperature or pressure difference) or a combination of two different sensors (e.g. a temperature measurement in conjunction with a pressure measurement). Alternatively, in the case that a threshold parameter is set relative to a single sensor, sensor thresholds as described herein may be determined based on a value (or other such signal) indicated by that single sensor at any given time.

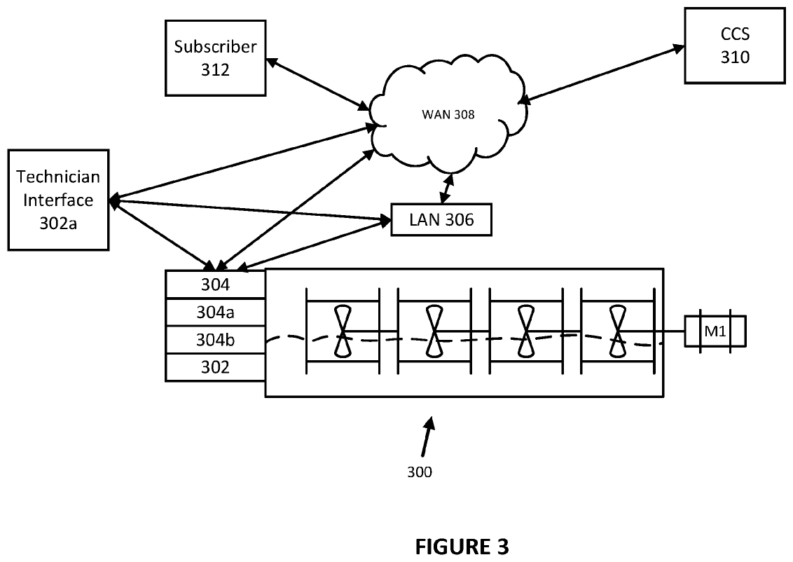

In various embodiments, as discussed below, the data collected from various sensors can be sent to a central computer system via the cloud/internet (e.g. as described below in relation to FIG. 3) for monitoring and/or analysis and may be enabled to have set-points adjusted by the central system.

In one example, a negative temperature coefficient (NTC) thermistor is implemented as a temperature sensor. NTC thermistors are resistors with a negative temperature coefficient, which means that the resistance decreases with increasing temperature. They are sometimes used as resistive temperature sensors and current-limiting devices. The temperature sensitivity coefficient is about five times greater than that of silicon temperature sensors (silistors) and about ten times greater than that of resistance temperature detectors (RTDs). NTC sensors may be used in a range from −55 to +200° C.

Other sensors may be configured to the FGCS including any one or more (or all) of:
Sound (e.g. microphone) 204f to monitor sound such as, for example, variations in moving parts. For example, active listening for changes in operational volumes of the FGCS can be used to remotely diagnose maintenance issues such as failures in various sub-systems including the fan and motor bearings or other sub-systems and/or confirm correct maintenance has been completed.
Movement (e.g. accelerometer) 204g to monitor operational movement of the FGCS. For example, changes in vibrations may be used to remotely diagnose maintenance issues as noted above.
Image (e.g. camera) 204e to visually confirm/inspect the system may be used, for example, for remote diagnosis of problems.

In addition, each of the above may be used to confirm correct maintenance has been completed.

### Network/Communication Example

In one embodiment, as shown in FIG. 3, a FGCS 300 is depicted within a communication network (e.g. WAN 308 and/or LAN 306).

In various embodiments, the FGCS 300 may communicate with a central computer system (CCS) 310 utilizing one or more of a variety of communication systems and protocols.

As shown in FIG. 3, the FGCS includes a user interface(s) 302, 302a and a network interface 304, including wired interface 304a and wireless interface 304b. User interface 302, if configured directly to the FGCS, may be an appropriate combination of a display screen(s), dials, knobs and the like that enable a technician/user to see data from and/or input data into the FGCS. User interface 302a may be an independent electronic device such as a laptop, tablet, smart phone and the like configured to communicate with the FGCS through a network interface via appropriate application software running on the electronic device.

Central computer systems 310 may include cloud-based data processing centers and/or independent computer systems 312 (e.g. subscribers) for receiving and analyzing system data. Communication systems may be one-way from each FGCS to central systems, one-way to individual FGCSs or two-way systems. Connectivity systems may change over time.

Interfaces 302, 302a may connect to the FGCS 300 via wired 304a or wireless 304b interfaces to enable technicians to interface with the FGCS for various purposes and/or functions including, as examples, system installation, commissioning and maintenance. Technicians may perform installation, commissioning and maintenance procedures through user interfaces 302, 302a depending on the particular configuration.

### Example Processor

FIG. 4 depicts representative aspects of a FGCS processor(s) 400 that may be configured to receive inputs from one or more sensors attached to the FGCS (and elsewhere) and to control the operation of the FGCS as described herein. As shown in FIG. 4, and as described herein, representative sensors may include one or humidity measurement signals (e.g. H1, H2, H3), temperature signals (e.g. T1-T4), pressure signals (e.g. ΔP1, ΔP2, ΔP3), pump signals (e.g. P1) and motor signals (e.g. M1 including on/off, voltage, amperage). Sensors may be configured as individual sensors and/or sensor pairs connected to different areas of the source gas equipment 104, the flue 106, the flue bypass 108, heat exchanger system 120, flue gas return 109 and the FGCS 100.

### Example Reaction in Reactor

As introduced above, waste flue gas from a hydrocarbon fueled heating device, such as, for example, a boiler, furnace, or hot water heater, can be introduced into a reactor of a FGCS containing anhydrous metal hydroxide, wherein CO₂ reacts in an exothermic reaction to produce heat and a carbonate. The anhydrous metal hydroxide within the reactor may be, for example, one or more of potassium hydroxide, sodium hydroxide, calcium hydroxide, and magnesium hydroxide, among other possible examples.

An example exothermic chemical reaction in reactor 102, is:

$$anhydrous metal hydroxide + {CO}_{2} \to {H}_{2} O + carbonate + heat \qquad EQ ( 1 )$$

In operation, flue gas exits the reactor 102 as processed flue gas where it passes through filter 102e and through heat exchanger 120a where heat is recovered for other uses. The system includes a fan 102g for drawing flue gas into and through the reactor 102 and returning the processed flue gas back to flue 106.

### Example Installation and Establishing Base Flow Rate

Referring back to FIG. 1, the FGCS 100 may be operated adjacent to source equipment 104 that has a primary function (e.g., within a building such as, for example, heating air or water). Installation of the FGCS 100 generally requires that the FGCS 100 when configured does not substantively interfere with the regular operation of the source equipment 104 and in particular, has minimal (or no) substantive impact on the flow of flue gases from flue 106.

Connecting a FGCS that redirects a portion of flue gas away from the main flue reduces both the volume and heat of the flue gas in the main flue. In addition, redirection also introduces flow restrictions that increase flow resistance. As a result, installation requires establishing connections and base operating conditions that do not substantively affect the operation of the flue 106 when the source equipment is operating or not and when the FGCS is operating or not.

By way of example, a furnace may have a flue configured with a 50-foot vertical flue. Hot flue gas, generated during operation of the furnace together with additional ambient air 104b drawn into the flue via a configured draft hood 104e (e.g., air drawn into the flue 106 via draft hood 104e), will rise within the flue 106 at varying rates depending on the output of the furnace at a given time. If a portion of flue gas is drawn out of the flue, there may be insufficient heat in the remaining portion of flue gas to induce adequate draft in the flue. That is, the flue gas may cool in the 50-foot flue such that the flow rate through the flue is inadequate.

Accordingly, it is desirable to have at least some base level of air movement through the FGCS most of the time for two main reasons including a) to ensure the FGCS has minimal impact on the operation of the flue and b) under certain environmental conditions, to minimize hardening of the reactant. For example, and in relation to the latter, ambient air contains some level of moisture, ranging from dry ambient air (e.g. cold climates) to humid ambient air (e.g. warm climates). Under various environmental conditions, the moisture content of the ambient air could cause reactant chemical to harden if consistently exposed to static ambient air. In some situations, continuous or substantially-continuous movement of ambient air through the reactor helps mitigate this undesirable outcome.

For example, a base flow rate of air (e.g. 80-160 cubic feet per minute (cfm)) may be established through the FGCS to ensure that flue performance is not affected under all operating conditions of the furnace and the FGCS. Determining a base flow rate will have consideration to various operational and environmental parameters of the source equipment including for example, outside temperature adjacent the flue, design cooling day, flue height, flue temperature, flue draft pressure both with the system operating and not operating.

An installation may consider factors such as and including, available space adjacent to the flue gas source equipment such as space in a mechanical room to enable the placement of the FGCS, available access to the mechanical room via access from the exterior of the building, correct gas-fired rating plate requirements and appropriate venting systems.

Typically, the technician or installer responsible for an installation must first measure the flue vent pressure rating at least 12 inches down-stream of the source equipment and ensure that any pressure differential will not negatively impact the operation of the source equipment prior to the installation of the FGCS as well as the pre-install flue gas temperature.

An example installation may include the following steps:
a) Test the draw pressure of the flue gas source equipment without the FGCS.
b) Determine proposed tie-in points for the flue gas bypass and flue gas return and connect the FGCS to flue. These tie-in connections will, for example, be about 12 inches apart;
c) Test effect of the FGCS on the operation of the flue gas source equipment and flue under a variety of operating conditions. Within examples, this will include configuring pressure sensors at the tie-in points and measuring the pressure in the flue when bypassing flue gas through the FGCS at different fan rates. This may include running the source equipment at a range of outputs including a low output (e.g. 10%) and a high output (e.g. 100%) and measuring the pressure drop between the pressure sensors at different FGCS fan speeds.
c) Determine a base FGCS fan speed and FGCS upper fan speed that ensures that the effect of the FGCS does not cause a pressure difference of greater than about 0.02 inches of water column pressure under the typical operating conditions of the source equipment.

For example, if the source equipment is operating at 10%, the draw pressure of the source equipment may be −1.0 inches of water column without the FGCS configured. As noted, the effect of connecting the FGCS to the flue should not affect water column pressure by more than 0.02 inches. Hence, in this example, a base speed of the FGCS fan may be set (e.g. by increasing the FGCS fan speed from zero) such that a sufficient volume of gas is passed through the FGCS such that the pressure difference is no more than 0.02 inches of water column when the source equipment is operating.

In some examples, the base flow rate of a FGCS 100 may be “set” and/or “configured” by a service technician responsible for installation of the FGCS, perhaps via user interface(s) 202, 202a after observing and/or testing conditions at the installation site and determining appropriate settings. In other examples, the base flow rate of a FGCS may be “set” and/or “configured” from a remote location via a control signal sent from a remote computing device, perhaps over one or more networks, and received by the FGCS via network interfaces 200d. In any event, in some examples, a FGCS may be manufactured and shipped with a “default” base flow rate stored in memory 200b, at which rate the FGCS will operate unless and until the base flow rate is updated.

Generally, after the FGCS has been configured to a flue 106, and the FGCS has been turned “on”, the FGCS will operate in a standby-mode where the fan 102g will operate at the base flow rate to maintain a standby or base-level flow of air through the FGCS subject to variations as described below.

### Monitoring System and Operational Modes

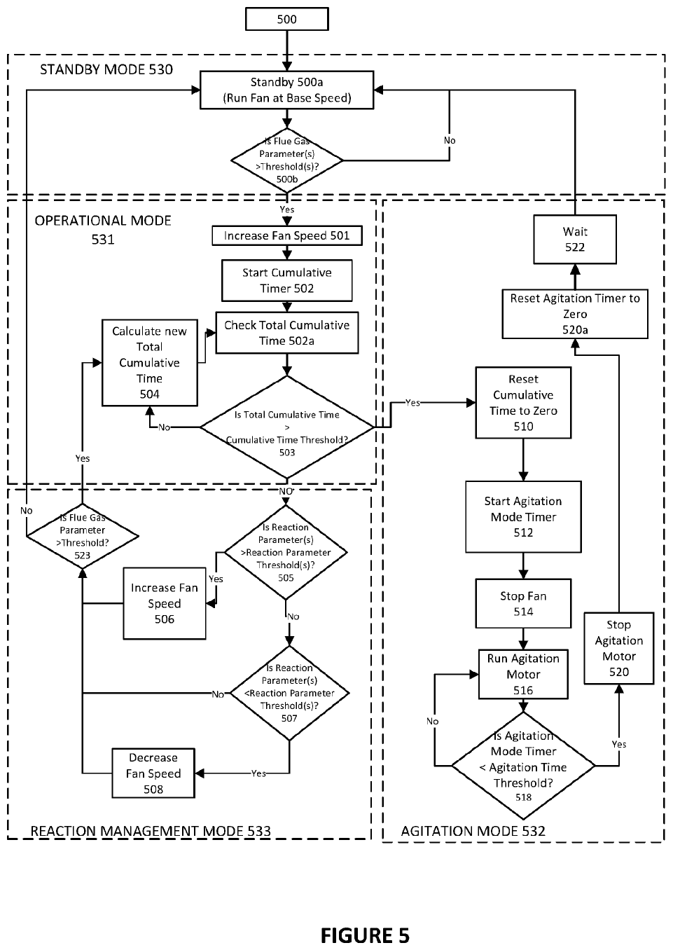

FIGS. 5-10 shows representative logic flow diagrams describing example monitoring systems enabling operation of the FGCS in various modes.

In an example, the logic described in relation to each of FIGS. 5-9 may be implemented as instructions stored in memory (e.g., the memory 200b of FIG. 2) and executed by one or more processors (e.g., the processor(s) 200a of FIG. 2) of a FGCS (e.g., the FGCS of FIGS. 1 and 2).

In general, the example logic, methods, and/or functions described below in connection with FIGS. 5-9 may be implemented within an operating environment including or involving, for example, the operating environment depicted in FIG. 1, a FGCS such as the example FGCS 100 depicted in FIG. 1, a FGCS such as the example FGCS 201 depicted in FIG. 2, a FGCS such as the example FGCS 300 depicted in FIG. 3, and/or any other devices, interfaces, and/or components depicted in connection with FIGS. 1-4 herein. Within examples, the logic, methods, and/or functions described below in connection with FIGS. 5-9 may be carried out by an FGCS itself, such as the example FGCS 100 depicted in FIG. 1, a FGCS such as the example FGCS 201 depicted in FIG. 2, or a FGCS such as the example FGCS 300 depicted in FIG. 3. In other examples, only certain such logic, methods, and/or methods may be performed by such an FGCS, and other logic, methods, and/or methods may be performed by other devices. For example, some logic, methods, and/or methods may be performed by another device such as CCS 310 or other such device that is in communication with an FGCS over one or more networks such as LAN 306 and/or WAN 308. Further, the logic, methods, and/or functions described below in connection with FIGS. 5-9 may include one or more operations, functions, or actions as illustrated by one or more of blocks contained within those Figures. Although the blocks are illustrated in sequential order, these blocks may also be performed in parallel, and/or in a different order than those described herein. Also, the various blocks may be combined into fewer blocks, divided into additional blocks, and/or removed based upon the desired implementation.

Further example functions of an example FGCS involving various monitoring systems (e.g. electronics 200 and associated sensors 204) and various modes are now described including standby mode 530, operational mode 531, agitation mode 532 and reaction management mode 533.

### Standby-Mode 530

In examples, after FGCS installation and determination of a base fan speed, as shown with reference to FIG. 5, the FGCS is started 500 and enters a standby mode 530 with the fan running at a base fan speed. Notably, while FIG. 5 depicts a standby mode 530 and a standby state 500a in which the fan of the FGCS runs at a base speed, in another example the fan might not run at all while in standby state 500a. That is, in some examples, the fan may not ever run while in standby state 500a, or alternatively the fan might run intermittently while operating in standby state 500a at a base speed.

In standby-mode 530, a monitoring system including one or more sensors configured to the flue and/or FGCS monitors operational conditions/parameters, and ultimately can determine the state of those conditions/parameters and use the determined state as a basis to cause the FGCS to enter different modes. For example, the FGCS can monitor if one or more flue gas parameter(s) is/are above a flue gas parameter threshold 500b. If the flue gas parameter(s) is/are not above the flue gas parameter threshold 500b, the monitoring system remains in standby state 500a. However, if the flue gas parameter(s) is/are above a threshold 500b, then the FGCS will transition to operating in an operational mode 531 (discussed further below) wherein, for example, the fan speed is increased 501 to a speed greater than the base speed of standby state 500a.

Various examples of flue gas parameters such as those contemplated in connection with block 500b exist. In examples, the flue gas parameter may serve to provide an indication of whether connected source equipment is currently on and generating desired levels of carbon dioxide. Accordingly, one such suitable flue gas parameter may be a measure of the temperature associated with the connected source equipment, such as the temperature of the flue and/or gas contained within the flue adjacent to the connected source equipment. Another such suitable flue gas parameter may be the actual carbon dioxide level contained within the gas (measured via a carbon dioxide sensor) within the flue adjacent to the connected source equipment. Other examples of suitable flue gas parameters exist including for example, pressures and flowrates and/or utilizing two or more separate flue gas parameters.

In an example where the monitored flue gas parameter is flue gas temperature, the FGCS 100 may be configured with a first temperature sensor T1 near the source equipment 104 (e.g. at a tie-in point 110 between flue 106 and bypass connector 108) as shown in FIG. 1. In accordance with this example, other placements of temperature sensor T1 may be suitable. Further, in other examples, multiple temperature sensors may be utilized and absolute values and/or temperature differences used as a basis for establishing thresholds.

In such an example, T1 monitors the temperature of flue gas exiting the source equipment. In some examples, when the source equipment is off for a sufficient period of time, T1 will be measuring ambient temperature as may be experienced at an installation. For example, if T1 is close to an exterior wall of a high latitude building and it is winter, the lowest base temperatures measured at T1 may be an outside temperature as low as −40° C.; alternatively, if T1 is well within a building that is always warm, the base temperature may be as high as +40° C. Over time, the temperatures measured at T1 will range from ambient temperatures if the source equipment has been off for a longer time to a maximum flue gas temperature if the source equipment is running at a maximum power output as well as all temperatures in between as the flue heats and cools.

When the source equipment turns on, the temperature measured at T1 will begin to rise due to the combustion process within the source equipment and as hot flue gas exits the source equipment. The monitoring system utilizes a threshold temperature, for example 100° C., that is used to trigger and otherwise monitor various operational cycles of the FGCS 100. In one example, the threshold temperature is established based on a determination of adequate flow rates of hot flue gas such that bypassing gas through the system maintains adequate draft in the flue. The threshold temperature may be set at a factory and/or may be adjusted by a technician at the time of installation or servicing as may be appropriate for a particular environment.

In an example, the monitoring system does not implement a threshold temperature that would result in automatically increasing fan speed 501 (ultimately diverting more flue gas through the FGCS) the moment the source equipment turns on. Instead, the FGCS might increase fan speed 501 (and increasing flow rates through the FGCS) after the source equipment has been operational for some time, and when sufficient heat, pressure and flow is being generated by the source equipment such that the flue gas will continue to properly exit the flue.

Further, the rise in temperature above a threshold temperature may be an indication that carbon dioxide is being produced at sufficient levels to be processed by the FGCS with desirable impact and/or efficiency. Thus, the flue gas parameter threshold may be set at a point at which the FGCS then transitions to the operational mode 531 upon meeting or exceeding the threshold. Alternatively, the flue gas parameter threshold may be set at a point at which the FGCS then waits a predetermined amount of time before transitioning to the operational mode 531 upon meeting or exceeding the flue gas parameter threshold.

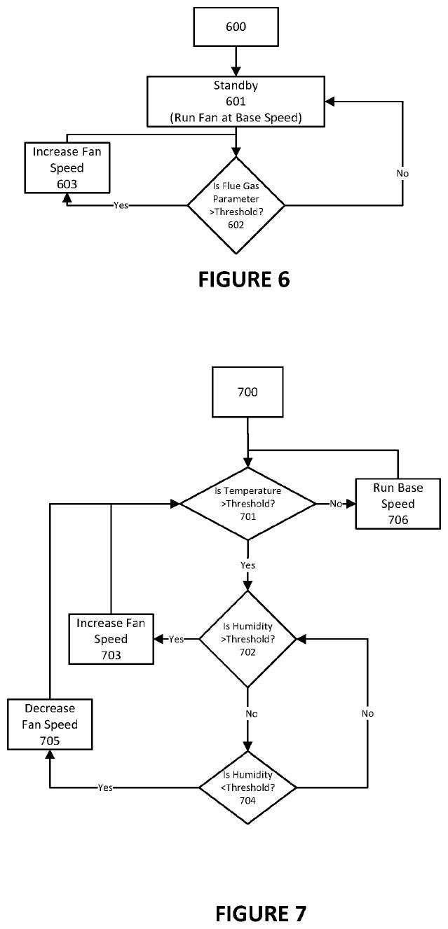

In various examples as depicted in both FIGS. 5 and 6, if T1 measures a drop below the threshold temperature, this is an indication that the source equipment may be off, and insufficient carbon dioxide and/or heat are being produced to be processed by the FGCS. When the source equipment is turned off, the production of carbon dioxide within the flue gas in the flue will drop off; however, an amount of heat will remain in the source equipment and usable heat may still be recovered from the source equipment for a period of time after the source equipment is turned off. Thus, once the temperature drops below the threshold temperature, the FGCS may return, either immediately or after some predetermined amount of time to standby mode 530 and standby state 500a, 601 whereby the fan is again run at base speed.

Thus, as discussed, in some examples when T1 measures temperature above the threshold temperature, the monitoring system increases the speed 501, 603 of the fan to bypass an increased volume of gas through the FGCS (discussed further in connection with operational mode). When T1 measures temperature below the threshold temperature, the system decreases the speed of the fan back to the base speed of standby mode 500a, 601.

### Operational-Mode 531

As noted, if a flue gas parameter threshold has been reached 500b, the monitoring system may then enter an operational-mode 531. Upon entering the operational-mode 531, the monitoring system increases fan speed 501 to provide additional flue gas flow through the FGCS.

After increasing fan speed 501, a source equipment cumulative timer may be started 502 and a total cumulative time checked 502a. The source equipment cumulative timer (also referred to herein as “cumulative timer”) determines the amount of time that the flue gas parameter threshold has been exceeded between resets (described below). The cumulative timer provides a direct or indirect measurement of the actual or an approximate amount of time that the source equipment has been operating and the total amount of time that the FGCS has been operating between cumulative timer resets.

A determination is then made if the total cumulative time is greater than a cumulative time threshold 503. If the total cumulative time is greater than the cumulative time threshold, the monitoring system may enter an agitation mode 532. If the total cumulative time is less than the cumulative time threshold, a new total cumulative time is calculated 504 and the monitoring system will continue to monitor the total cumulative time 502a, 503 until the cumulative threshold time is reached.

As introduced above and discussed further below, the cumulative timer provides an indication of how long the FGCS has operated in the operational mode 531 and/or a reaction management mode 533 discussed below. In general, after some period of time of operation in such modes, it may be desirable to transition the FGCS to an agitation mode 532 in which the fan is turned off and the reactant mixture within the reactor is agitated (i.e., stirred/mixed) for a time before then returning to standby mode 530 and/or ultimately operational mode 531. unning the agitation mode 532 may break up solid reactant that may be partially dried and is in clumps and/or may stir reactant that may be in a semi-liquid form.

The speed to which the fan is increased 501 may vary depending on the size of the FGCS, the source equipment installation and/or environmental characteristics of the environment in which the FGCS is installed and may also be impacted by the source equipment to which the FGCS is connected (e.g. the size and “class” of the source equipment). Fan speeds may be pre-set fan speeds (e.g. first speed, second speed, etc.) or may be continuously variable, perhaps between zero and an upper speed.

As noted, in general, it is desirable that the FGCS does not undesirably impact the operation of the source equipment/flue to which it is connected. In an example, the operational mode fan speed will be set at a level, as with standby mode, wherein operation in the operational mode 530 does not drive an unacceptable change in a pressure difference measured between upstream and downstream the FGCS. In an example, in operational mode the fan speed will be set at a level such that operation does result in a pressure differential of more than 0.02 inches of water column pressure across the FGCS installation. In an example, the fan speed would be set at a level that corresponds to moving air at 80-160 cubic feet/minute through the FGCS whilst in operational mode 531.

In examples, if the source equipment has been turned on and the FGCS eventually enters the operational mode 531, the monitoring system increases fan speed above the base fan speed. Further, while in the operational mode, the monitoring system measures cumulative time associated with the flue gas equipment exceeding a threshold that can be used for making other operational decisions including whether to enter, for example, the agitation mode 532 or the reaction management mode 533. That is, if the cumulative run time of the source equipment exceeds the cumulative time threshold, the monitoring system may enter the agitation mode 532. Conversely, if the cumulative run time of the source equipment has not exceeded the cumulative time threshold, the monitoring system may enter the reaction management mode 533.

An example cumulative threshold time may be in the range of 10-120 minutes; however, such thresholds may be determined having consideration to numerous parameters. Such parameters may be set and/or updated, locally and/or remotely, by a service technician, machine learning algorithms, and/or through a central computer system.

### Reaction Monitoring-Mode 533

As noted previously, while the total cumulative time is less than the cumulative time threshold, the monitoring system may enter a reaction monitoring mode 533. In reaction-monitoring mode, the monitoring system is monitoring one or more reaction parameters to determine if the reaction parameter(s) is/are greater than a reaction threshold 505. If a reaction parameter is greater than a reaction threshold 505, fan speed may be increased 506. If a reaction parameter is less than a reaction threshold 507, fan speed may be decreased 508. As fan speed is increased 506 or decreased 508, the monitoring system will then check if the flue gas parameter(s) is/are above a flue gas parameter(s) threshold 523. If the flue parameter(s) threshold(s) is/are exceeded (e.g. the source equipment remains on), the monitoring system returns to operational mode 531 to calculate a new total cumulative time 504. If the flue parameter(s) threshold(s) is/are not exceeded (e.g. the source equipment has turned off), the monitoring system returns to standby mode 530.

As discussed further below, the reaction parameter(s) that is/are monitored may take a variety of suitable forms. In examples, the reaction parameter(s) will be chosen such that it provides an indication of whether the fan speed of the FGCS should remain constant and/or should be increased/decreased. For instance, the reaction parameter(s) might provide an indication of whether the reaction within the reactor may be assisted or otherwise improved by increasing or decreasing the fan speed. In one example, the reaction parameter is a measured humidity level within the reaction chamber (e.g., using humidity sensors H1 and H2 of FIG. 1). Accordingly, if it is determined that high humidity is present in the reactor, it may be desirable to further increase the fan speed to remove water. On the other hand, if it is determined that a low amount of humidity is present in the reactor, it may be desirable to decrease the fan speed.

For example, as the reaction progresses, water will be generated within the reactor, which will generally combine with the reactant transforming the reactant to a viscous liquid and reduce the ability of CO₂ to react due to a loss of surface area. The humidity within the FGCS will also rise due to the generation of water. By increasing fan speed, additional heat will be drawn through the FGCS due to an increased flow, and humidity will be removed from the FGCS. This assists in transforming the reactant back to a drier form and ultimately assists in generating a high-quality product. When the humidity drops below a particular level, this is an indication that the reactant is in a dry form (either reacted or unreacted) and that water removal at that instance is not required.

Another reaction parameter may be the relative viscosity of the reactant as may be measured within the FGCS. In one example, viscosity may be measured by the power requirement to stir the reactants that may be measured by the agitation system during an agitation cycle or by a separate viscosity measurement system (e.g. 102f. 204h). For example, the agitation system may include a fixed speed motor (e.g. 102d or 202d). Power required to maintain a fixed speed may vary based on the relative viscosity of the reactant where a more viscous reactant will require higher power to maintain the fixed speed.

In an example, the FGCS is configured with a humidity sensor H1 downstream of the reactor 102 to measure the humidity of processed flue gas. In other examples, the humidity sensor H1 may be placed in any other suitable location including, for example, within the reactor. As the reaction progresses, water/water-vapor are produced within the reactor and will increase the humidity of the processed flue gas such that H1 will measure a higher humidity compared to the humidity of the flue gas exiting the source equipment. Accordingly, to the extent that humidity is “high”, this provides an indication that the reaction is progressing and/or that consistency of the reactants has changed. Differences in humidity measurements between humidity sensors may be used as a basis for determining if a threshold is met or not.

As described above, the consistency of the solid reactant will be changing throughout the reaction and develop different consistency at different times. For example, a typical solid reactant may initially be “dry flakes” at the time the reactant is introduced into the reactor and will thereafter transform to a viscous thickened mixture as the reaction proceeds. Without stirring/mixing, the viscous mixture can transform to dry “clumps” under heating or even a solid block. Ultimately, spent reactant is desirably a dry powder.

For example, if the humidity has risen above a humidity threshold (e.g. 40% relative humidity), the monitoring system increases the flow rate of flue gas through the reactor to promote gas flow over the reactant and cause it to dry by increasing fan speed and increasing heat flow into the reactor. Upon operation of the fan for a period of time, if the humidity drops below the humidity threshold, the fan speed may be reduced to a lower fan speed. If the detected humidity drops below a lower humidity threshold (e.g. 10% relative humidity), this may be used to indicate that the reactant is spent.

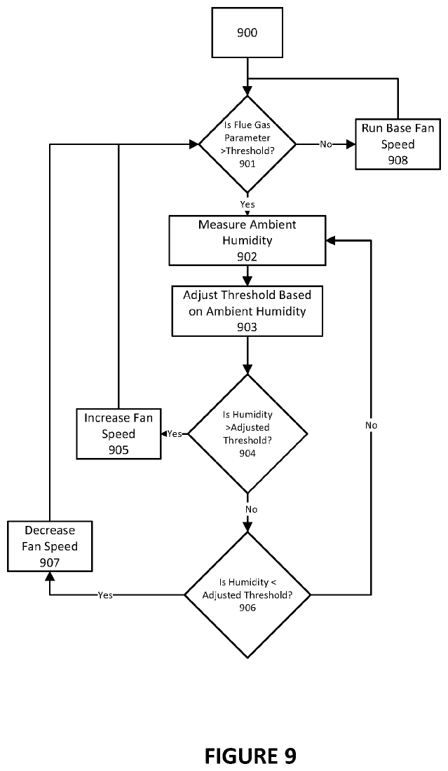

As ambient relative humidity may be higher than 40%, the monitoring system may be configured with an external humidity sensor (e.g. H3) that may be configured to the monitoring system to enable the monitoring system to determine if humidity in the FGCS is the true reactor humidity or has resulted from ambient humidity. That is, if the monitoring system is in a standby mode for a period of time, and the ambient humidity is high, the measured humidity may be high due to humid air being drawn through the FGCS via the draft hood. In one embodiment, the monitoring system measures and takes into account ambient humidity, when activating and deactivating various processing modes as described further below in relation to FIG. 9. For example, the monitoring system may measure ambient humidity 902 and adjust a reaction parameter threshold based on ambient humidity. For example, if measured ambient humidity is measured at 90%, the monitoring system may adjust thresholds on which other decisions may be made, at least for a period of time, to establish “steady-state” conditions within the FGCS before returning to other thresholds.

In one embodiment, the set fan speed may be linearly correlated to an absolute humidity measurement where an increase in fan speed is directly proportional to an increase in absolute humidity. Alternatively, the fan speed may be non-linearly correlated to an absolute humidity measurement. For example, an absolute humidity measurement above a threshold may be used to increase fan speed at a proportionally higher rate as compared to a linear correlation. Such a control scheme may be desired to match the relative reaction rate with the reactor when it is known that the reaction rate is non-linear having consideration to input parameters.

In one embodiment, the FGCS is configured with a viscosity sensor (e.g. 102f, 204h) and the reaction parameter is measured viscosity. In another embodiment, power input to the agitation system is measured during an agitation cycle and is stored in memory (e.g. 200b) and utilized as a reaction parameter the next time the monitoring system enters the reaction management mode and until the next time the monitoring system enters the agitation mode and a new viscosity measurement is determined.

### Agitation Mode 532

Once the total cumulative time is greater than the time threshold 503, the monitoring system may enter the agitation mode 532. In the agitation mode, the monitoring System activates one or more components within the reactor to stir or mix the contents of the reactor (i.e., the reactant). As discussed further below, in an example the agitation mode may involve activating an agitation system 202b such as that discussed above in connection with FIG. 2. Activation of the agitation system may involve powering or otherwise turning on one or more motor drives 202d that drive one or more respective stirring paddles 202c.

In some examples, the FGCS may enter the agitation mode 532 immediately after it is determined that the total cumulative time is greater than the cumulative time threshold 503. In an alternative example (not shown in FIG. 5), the FGCS may enter the agitation mode both after it is determined that the total cumulative time has exceeded the cumulative time threshold and it is determined that the connected source equipment is not currently operating. This is because it may be possible to improve the efficiency of operation of the overall system in some respects if the FGCS does not operate in the agitation mode (whereby the fan is stopped 514) at the same time that the connected source equipment is operating.

In an example, when the FGCS initially enters the agitation mode 532, the cumulative timer is reset to zero 510. As a result, the monitoring system has transitioned to operating in the agitation mode 532 based on how long the FGCS has operated in the operational mode 531. Notably, if the FGCS then later reenters the operational mode 531, the monitoring system will start again (restart) the cumulative timer 502 to provide a new indication of how long the FGCS has been in operational mode after a cumulative timer reset.

Further, after the monitoring system enters the agitation mode 532, an agitation mode timer is started 512. The agitation mode timer will then generally accumulate while the monitoring system is operating in the agitation mode. The agitation mode timer therefore provides an indication of how long the monitoring system has been in agitation mode. As discussed further below, the agitation mode timer may be referenced in connection with a determination of whether the agitation mode timer does or does not exceed an agitation time threshold 518.

Further, after the monitoring system enters the agitation mode, the fan is stopped 514. Stoppage of the fan results in the total volume of airflow passing through and out of the reactor 102, and into/through downstream components including filter 102e to decrease and/or even stop or substantially stop. As a result, the amount of material, reactant, or other solids carried away from the reactor 102 and into downstream components such as filter 102e may be decreased. This is desirable to the extent that in following block 516 the agitation motor is then activated. That is, because the agitation motor generally agitates the reactant, it is desirable to first turn the fan off 514 to help minimize the amount of agitated reactant/material that exits the reactor and/or is carried into the filter.

Stopping the fan completely while agitation is underway can substantially improve the life of the filter as the fan is not actively drawing particles into the filter during agitation when there is the highest likelihood/concentration of airborne particles.

Notably, in one example, when the monitoring system is configured to initiate an agitation cycle immediately upon reaching the total cumulative time threshold, if the source equipment is either a) on or b) turned off or c) turned on again during the agitation cycle, there is no bypass of flue gas to the FGCS as the fan is not operating and thus, substantially all flue gas passes up the flue 106 and will not carry particulates into the filter.

As noted, the monitoring system then turns on agitation system including running the motor 516 (e.g., one or more motor drives 202d which drives corresponding agitation devices such as paddles within the reactor).

Once the motor 516 is turned on, the monitoring system monitors whether the agitation mode timer is less than a time threshold 518. If the agitation mode timer is less than a threshold, the motor continues to run 516. If the agitation mode timer is greater than a threshold, the motor is stopped 520.

If the agitation motor has been stopped 520, the monitoring system may wait 522 for a time before returning to standby-mode 500a and reset agitation mode timer to zero 520a. One benefit of waiting before returning to standby mode may be to provide an opportunity for any floating reactant or other material within the reactor to more fully settle prior to reactivating the fan. As a result, the monitoring system will further mitigate the amount of material that is lost outside of the reactor and/or trapped in the filter.

In one example, as noted above, the FGCS enters the agitation mode 532 after determining the cumulative operating time of source equipment (perhaps within an operational mode and/or other modes) has exceeded a cumulative time threshold. In general, entering the agitation mode after some period of operation may provide a variety of operational benefits, including some benefits that help the reaction within the reactor proceed efficiently and to avoid “build up” of detrimental operational conditions over time. In various examples, the agitation mode is operated to achieve four example objectives, among other potential objectives and benefits, including:
to agitate the liquid/solid reactant to manage the consistency of the reactant;
to increase the surface area of reactant available to flue gas;
to operate the FGCS in a manner that mitigates the loss of reactant; and
to operate the FGCS to mitigate filter clogging.

### Example Involving Measurement of Operation Time of Source Equipment

In one example, as an alternative to directly monitoring the total cumulative time that the FGCS operates in operational mode 531 (in accordance with block 503), the monitoring system instead of additionally may measure the total cumulative time that the source equipment has been running and activates the agitation mode after the source equipment has operated through one or more heating cycles. In one embodiment, and by way of example, each time T1 measures a temperature rise above the threshold temperature, the monitoring system calculates the total elapsed time that the temperature is above the threshold temperature until the temperature drops below the threshold temperature. As time above threshold temperature is an indication of the time that the source equipment has been on, the system can determine the total cumulative running time of the source equipment which may be approximate or absolute. Upon reaching a total cumulative threshold time, the monitoring system will initiate the agitation mode 532.

For example, a furnace may run for 5 minutes and then shut-off for 10 minutes, run again for 7 minutes and shut-off again for 8 minutes and then run a third time for 4 minutes, etc. In this example, the total cumulative run time is 16 minutes. The monitoring system may be set up such that if the total cumulative time exceeds, for example 15 minutes, the FGCS enters the agitation mode when the source equipment is next off. That is, if the total cumulative time is greater than 15 minutes and the temperature is less than the threshold temperature, the monitoring system runs an agitation cycle. In various embodiments, within agitation mode 532, the agitation cycle is run immediately upon the total cumulative time threshold being reached regardless of whether the source equipment is on or off or is only run the next time the source equipment is off.

In various embodiments, adjustment of set points may be determined based on seasonal variations in the operation of the source equipment and/or atmospheric conditions. For example, a furnace or boiler may operate for very different intervals throughout a year; wherein various parameters including cumulative times, motor times, and temperature and humidity thresholds may be adjusted for different seasons.

### ADDITIONAL EXAMPLES

In examples, the FGCS may run based on data received from sensors configured to the FGCS, associated source equipment, flues and environment. It should be understood that while a variety of functions and alternative modes of operation are described above, it is possible that certain of those functions may be performed alone or in different orders and combinations based on the specific sensors or combinations of sensors that may be configured. FIGS. 6-9 provide additional representations of various example functions and modes of operation.

FIG. 6 describes a mode 600 where the monitoring system may increase or decrease fan speed based on detection of a flue gas parameter 602 that is another example of transitioning from a standby mode to an operational mode as described in reference to FIG. 5. In this example, if the flue gas parameter exceeds a threshold 602, the fan speed is increased 603 or maintained if the flue gas parameter is below a threshold 602 or returned to a base speed 601.

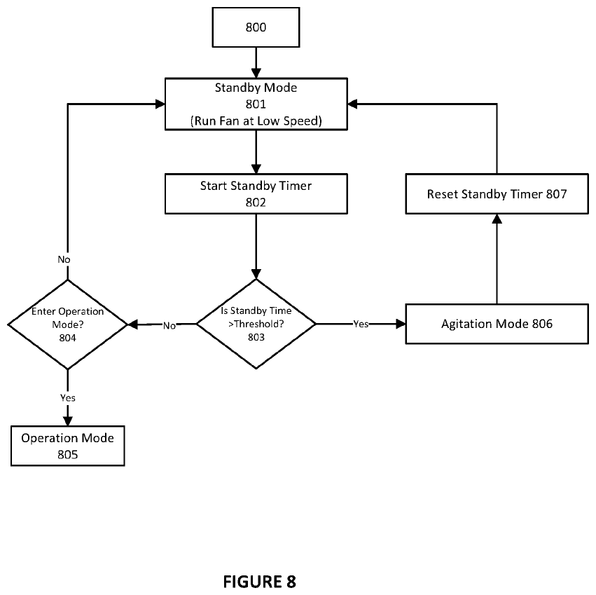

FIG. 7 describes a mode 700 where the monitoring system specifically monitors temperature 701 and humidity. In this mode, the monitoring system may increase 703 or decrease 705 fan speed based on detection of a humidity parameter 702, 704. In this case, if the humidity parameter exceeds a threshold 702, the fan speed is increased 703 or, if the humidity parameter is below a threshold 704, the fan speed is decreased 705. In either case, the temperature threshold is again checked 701 to repeat the humidity measurement 702, 704 or return to base speed 706. FIG. 7 shows a mode that is specifically measuring humidity as a reaction parameter as compared to the more generalized method of measuring one or more reaction parameters as described in relation to FIG. 5.

FIG. 8 describes a mode 800 where the monitoring system determines based on source equipment and FGCS parameters whether to enter an operation mode 805 or agitation mode 806. In this example, from standby mode 801, the monitoring system may start and run a standby timer 802 until a standby time threshold is reached to decide whether to enter the operation mode 805 or agitation mode 806. Standby timer may be reset 807 after an agitation mode 806 is run. This mode 800 may be run when the source equipment is not being run regularly and agitation of the reactor is periodically desired. For example, this operating mode may be desired if the source equipment (e.g. a furnace) is off for longer periods of time, for example, during spring, summer and autumn, when there may be greater periods of time between on cycles. In this mode, a standby time threshold may be set to be 24 hours, wherein if the source equipment does not turn on for 24 hours, the monitoring system will enter the agitation mode to stir the reactants within the FGCS. This mode may be desired in locations where the ambient humidity may be high and the base fan speed causes humidity to be introduced into the FGCS which, without agitation could cause the reactant to turn to a solid block. As such, in this mode, regardless of whether the source equipment has been turned on for a period of time, the monitoring system will regularly stir the reactants.

FIG. 9 depicts an operating mode 900 in which the monitoring system takes into account ambient humidity to adjust a threshold (e.g. a humidity threshold). For example, and as with FIG. 5, if the monitoring system enters an operational mode based on flue gas parameter(s) exceeding a threshold 901, and/or a reaction management mode, the monitoring System may measure ambient humidity 902 and adjust a threshold 903 based on ambient humidity as a method of deciding to increase fan speed 905 (if humidity is greater than an adjusted threshold 904) or decrease fan speed 907 (if humidity is less than an adjusted threshold 906). For example, if measured ambient humidity is high (e.g. 90%), the monitoring system may adjust thresholds on which other decisions may be made, at least for a period of time, to establish “steady-state” conditions within the FGCS before returning to other thresholds. If humidity is not less than the adjusted threshold, the monitoring system may return to measuring ambient humidity 902. If the flue gas parameter is less than the flue gas parameter threshold, the monitoring system may run the fan at base speed 908.

### EXAMPLE EMBODIMENTS

By way of illustration, the Applicant presently offers (or has offered) for sale certain flue gas capture systems including, for example, CarbinX™ including versions 3.0, 3.1, 3.2, 3.3, 3.4, and 3.5. Other suitable flue gas capture systems may additionally or alternatively be used to implement aspects of example flue gas capture systems described herein.

Although the present invention has been described and illustrated with respect to preferred embodiments and preferred uses thereof, it is not to be so limited since modifications and changes can be made therein which are within the full, intended scope of the invention as understood by those skilled in the art.

For example, and without limitation, some embodiments include system comprising, among other features, (i) a reactor having a flue gas inlet for connection to a flue gas source, a mixing system configured to mechanically agitate a solid reactant within the reactor, a gas outlet and a flue gas return system for connection to a flue; (ii) a fan configured to the gas outlet for drawing flue gas through and out of the reactor and to the flue gas return system, the fan operable at a fan speed; (iii) at least one flue gas parameter sensor configured to any one of or a combination of the flue gas inlet, flue gas source or flue; (iv) at least one processor configured to the at least one flue gas parameter sensor and to the fan; and (v) tangible, non-transitory computer-readable media comprising program instructions executable by the at least one processor such that the system is configured to, among other features, in response to at least one flue gas parameter threshold being exceeded, the processor increases fan speed and in response to at least one flue gas parameter threshold not being exceeded decreases fan speed.

In some embodiments, the at least one processor is configured to activate a standby mode and remain in the standby mode while the at least one flue gas parameter threshold has not been exceeded, and to maintain fan speed at a base fan speed in standby mode.

In some embodiments, the at least one processor is configured, in response to at least one flue gas parameter threshold being exceeded, to start a cumulative timer and to calculate a total cumulative time when the at least one flue gas parameter threshold is exceeded.

In some embodiments, the at least one processor is configured, in response to the total cumulative time exceeding a cumulative time threshold, to activate an agitation mode.

In some embodiments, the processor is configured, in response to activation of the agitation mode, to reset the cumulative timer to zero.

In some embodiments, the at least one processor is configured, in response to activation of the agitation mode, to start an agitation mode timer and to activate the mixing system.

In some embodiments, the at least one processor is configured, in response to activation of the agitation mode, to stop the fan.

In some embodiments, the at least one processor is configured, in response to the agitation mode timer exceeding an agitation mode time threshold, to stop the agitation system.

In some embodiments, the at least one processor is configured, in response to the agitation mode timer exceeding an agitation mode time threshold, to stop the agitation system and to run the fan at a base speed.

In some embodiments, the at least one processor is configured, in response to the agitation mode timer exceeding an agitation mode time threshold, to stop the agitation system and to run the fan at a base speed after a delay time.

In some embodiments, the at least one processor is configured, in response to the total cumulative time not exceeding a cumulative time threshold, to activate a reaction management mode.

Some embodiments additionally include at least one reaction parameter sensor configured to the reactor. In some such embodiments, the at least one processor is configured, in response to activation of the reaction management mode, to determine if at least one reaction parameter is exceeded, and if exceeded to increase fan speed.

In some embodiments, the at least one processor is configured, in response to activation of the reaction management mode, to determine if at least one reaction parameter is not exceeded, and if not exceeded to decrease fan speed.

In some embodiments, the at least one flue gas parameter sensor includes any one or more (or all) of (i) a temperature sensor, (ii) a carbon dioxide concentration sensor, and/or (iii) a humidity sensor.

In some embodiments that include a humidity sensor, the processor is configured to control fan speed based on a linear correlation to an absolute humidity measurement between a low humidity threshold and a high humidity threshold and where low fan speed is correlated to a lower absolute humidity measurement.

In some embodiments that include a humidity sensor, the processor is configured to control fan speed based on a non-linear correlation to an absolute humidity measurement between a low humidity threshold and a high humidity threshold and where a higher absolute humidity measurement results in a proportionally higher fan speed.

In some embodiments, the at least one reaction parameter sensor includes a viscosity sensor.

In some embodiments, the at least one processor is configured to start a standby timer in standby mode and wherein if a standby timer threshold is exceeded, to enter an agitation mode.

Some embodiments additionally include at least one network interface communicatively coupled to the at least one processor. In some such embodiments, the at least one network interface and the at least one processor are configured to report sensor data to a central computer system over at least one network and to receive instructions from the central computer system.

Some embodiments additionally include an image capture system configured to the at least one processor for capturing image data of the system.

Some embodiments additionally include a sound capture system configured to the at least one processor for capturing sound data of the system.

Some embodiments additionally include a movement capture system configured to the at least one processor for capturing movement data of the system.

Some embodiments additionally include a user interface configured to the at least one processor to display system data to a user and to enable a user to enter data.

Some embodiments additionally or alternatively include methods of operating a flue gas capture system, where the flue gas capture system includes (i) at least one processor operable in a standby mode, (ii) tangible, non-transitory computer-readable media comprising program instructions executable by the at least one processor, (iii) a mixing system, (iv) a fan and (v) at least one flue gas parameter sensor configured to a flue gas source. In some such embodiments, the methods include, among other features (a) in response to a flue gas parameter threshold being exceeded, increasing fan speed; and (b) in response to at least one flue gas parameter threshold not being exceeded, decreasing fan speed

In some embodiments, the methods additionally include the step of maintaining a base fan speed when the at least one processor is operating in the standby mode.

In some embodiments, the methods further include, starting a cumulative timer and calculating a total cumulative time after (or perhaps in response to) determining that at least one flue gas parameter threshold is exceeded.

In some embodiments, the methods further include activating an agitation mode after (or perhaps in response to) determining that the total cumulative time exceeds a cumulative time threshold.

In some embodiments, the methods further include resetting the cumulative timer to zero after (or perhaps in response to) activation of the agitation mode.

In some embodiments, the methods further include the step of starting an agitation mode timer and activating the mixing system after (or perhaps in response to) activation of the agitation mode.

In some embodiments, the methods further include the step of stopping the fan after (or perhaps in response to) activation of the agitation mode.

In some embodiments, the methods further include the step of stopping the agitation system after (or perhaps in response to) the agitation mode timer exceeding an agitation mode time threshold.

In some embodiments, the methods further include the step of stopping the agitation system and running the fan at a base speed after (or perhaps in response to) the agitation mode timer exceeding an agitation mode time threshold.

In some embodiments, the methods further include the step of stopping the agitation system and running the fan at a base speed after a delay time after (or perhaps in response to) determining that the agitation mode timer exceeds an agitation mode time threshold.

In some embodiments, the methods further include the step of activating a reaction management mode after (or perhaps in response to) determining that the total cumulative time does not exceed a cumulative time threshold.

In some embodiments, the flue gas capture system further comprises at least one reaction parameter sensor configured to the reactor. In some such embodiments, the methods further include the step of increasing fan speed after (or perhaps in response to) activation of the reaction management mode.

In some embodiments, the methods include, after (or perhaps in response to) activation of the reaction management mode, determining if at least one reaction parameter is not exceeded. And after (or perhaps in response to) determining that the at least one reaction parameter is not exceeded, i decreasing fan speed.

In some embodiments, the at least one flue gas parameter sensor includes a temperature sensor, and the methods further comprise the step of monitoring flue gas temperature via the temperature sensor.

In some embodiments, the at least one flue gas parameter sensor includes a carbon dioxide concentration sensor, and the methods further comprise the step of monitoring flue gas carbon dioxide concentration via the carbon dioxide concentration sensor.

In some embodiments, the at least one reaction parameter sensor includes a humidity sensor, and the methods further comprise the step of monitoring flue gas humidity via the humidity sensor.

In some embodiments, the at least one reaction parameter sensor includes a viscosity sensor, and the method further comprises the step of monitoring reactant viscosity via the viscosity sensor.

In some embodiments, the at least one processor is configured to start a standby timer in standby mode. In some such embodiments, the methods additionally include entering an agitation mode after (or perhaps in response to) determining that a standby timer threshold has been exceeded.

In operation, any of the flue gas system components described in any of the example embodiments (or any other embodiments disclosed herein) and/or any of the method steps described in any of the example embodiments (or any other embodiments disclosed herein) can be combined in any suitable combination.

What is claimed is:

1. A system comprising:
a reaction chamber comprising (i) a gas inlet coupled to a gas source and (ii) a gas outlet;
at least one sensor;
at least one fan, wherein the at least one fan is operable at at least a first fan speed and a second fan speed, wherein the second fan speed is greater than the first fan speed;
at least one processor; and
tangible, non-transitory computer-readable media comprising program instructions executable by the at least one processor such that the system is configured to:
while the at least one fan is operating at the first fan speed, receive, via the at least one sensor, a parameter signal indicating a parameter corresponding to the gas source;
based on the received parameter signal, determine that the parameter corresponding to the gas source is above a parameter-threshold level; and
based on the determination that the parameter is above the parameter-threshold level, cause the at least one fan to transition from operating at the first fan speed to operating at the second fan speed.

2. The system of claim 1, wherein the at least one sensor comprises a first sensor, wherein the system further comprises a second sensor, and wherein the program instructions executable by the at least one processor comprise further program instructions executable by the at least one processor such that the system is further configured to:
while the at least one fan is operating at the second fan speed, receive, via the second sensor, a humidity signal indicating a humidity level corresponding to the reaction chamber;
based on the received humidity signal, determine that the humidity level corresponding to the reaction chamber is above a humidity-threshold level; and
based on the determination that the humidity level is above the humidity-threshold level, cause the at least one fan to transition from operating at the second fan speed to operating at a third fan speed, wherein the third fan speed is greater than the second fan speed.

3. The system of claim 2, wherein the humidity signal comprises a first humidity signal, and wherein the program instructions executable by the at least one processor comprise further program instructions executable by the at least one processor such that the system is further configured to:
while the at least one fan is operating at the third fan speed, receive, via the second sensor, a second humidity signal;
based on the received second humidity signal, determine that the humidity level corresponding to the reaction chamber is below the humidity-threshold level; and
based on the determination that the humidity level is below the humidity-threshold level, cause the at least one fan to transition from operating at the third fan speed to operating at a fourth fan speed, wherein the fourth fan speed is less than the third fan speed.

4. The system of claim 3, wherein the fourth fan speed is the same as the second fan speed.

5. The system of claim 1, wherein the system further comprises an agitation system, and wherein the program instructions executable by the at least one processor comprise further program instructions executable by the at least one processor such that the system is further configured to:
after causing the at least one fan to transition from operating at the first fan speed to operating at the second fan speed, (a) cause the at least one fan to stop and (b) activate the agitation system.

6. The system of claim 5, wherein the program instructions executable by the at least one processor such that the system is further configured to activate the agitation system comprise program instructions executable by the at least one processor such that the system is configured to:
activate at least one motor of the agitation system, wherein the at least one motor is configured to drive at least one stirring paddle.

7. The system of claim 6, wherein the program instructions executable by the at least one processor comprise further program instructions executable by the at least one processor such that the system is further configured to:
before causing the at least one fan to stop and activating the agitation system, determine that a cumulative operational time has elapsed since causing the at least one fan to transition from operating at the first fan speed to operating at the second fan speed; and
determine that the determined cumulative operational time is greater than a cumulative operational time threshold.

8. The system of claim 5, wherein the program instructions executable by the at least one processor comprise further program instructions executable by the at least one processor such that the system is further configured to:
after causing the at least one fan to stop and activating the agitation system, determine that a cumulative agitation time has elapsed since activating the agitation system;
determine that the determined cumulative agitation time is greater than a cumulative agitation time threshold; and
after determining that the determined cumulative agitation time is greater than the cumulative agitation time threshold, deactivate the agitation system.

9. The system of claim 1, wherein the at least one sensor comprises a first sensor, wherein the system further comprises a second sensor, and wherein the program instructions executable by the at least one processor comprise further program instructions executable by the at least one processor such that the system is further configured to:
before determining that the parameter corresponding to the gas source is above the parameter-threshold level, receive, via the second sensor, a humidity signal indicating a humidity level corresponding to the reaction chamber;
based on the received humidity signal, determine that the humidity level corresponding to the reaction chamber is above a humidity-threshold level; and
based on the determination that the humidity level is above the humidity-threshold level, cause the at least one fan to transition from operating at the first fan speed to operating at a second fan speed, wherein the second fan speed is greater than the first fan speed.

10. The system of claim 1, wherein the system further comprises at least one network interface, and wherein the program instructions executable by the at least one processor comprise further program instructions executable by the at least one processor such that the system is further configured to:
before the at least one fan operates at the first fan speed, receive, via the network interface over at least one wide area network (WAN), an indication of the first fan speed.

11. The system of claim 1, wherein the system further comprises at least one user interface, and wherein the program instructions executable by the at least one processor comprise further program instructions executable by the at least one processor such that the system is further configured to:
before the at least one fan operates at the first fan speed, receive, via the at least one user interface, an indication of the first fan speed.

12. The system of claim 1, wherein the system further comprises at least one network interface, and wherein the program instructions executable by the at least one processor comprise further program instructions executable by the at least one processor such that the system is further configured to:
while the at least one fan is operating at the first fan speed, transmit, via the network interface over at least one wide area network (WAN) to a computing system, an indication of the first fan speed.

13. The system of claim 12, wherein the system further comprises at least one network interface, and wherein the program instructions executable by the at least one processor comprise further program instructions executable by the at least one processor such that the system is further configured to:
after causing the at least one fan to transition from operating at the first fan speed to operating at the second fan speed, transmit, via the network interface over the at least one WAN to the computing system, an indication of the second fan speed.

14. The system of claim 1, wherein the system further comprises at least one network interface, and wherein the program instructions executable by the at least one processor comprise further program instructions executable by the at least one processor such that the system is further configured to:
after receiving the parameter signal indicating a parameter corresponding to the gas source, transmit, via the network interface over at least one wide area network (WAN) to a computing system, the indication of the parameter corresponding to the gas source.

15. The system of claim 1, wherein the at least one sensor comprises a temperature sensor, and wherein the parameter corresponding to the gas source comprises a temperature corresponding to the gas source.

16. The system of claim 1, wherein the at least one sensor comprises the at least one sensor coupled to at least one of (i) the gas source, (ii) a flue, or (iii) a bypass flue.

17. The system of claim 1, wherein the at least one sensor is coupled to the gas source.

18. The system of claim 1, wherein the at least one fan is coupled to the gas outlet.

19. A method comprising:
while at least one fan of a flue gas processing system is operating at a first fan speed, receiving, via at least one sensor, a parameter signal indicating a parameter corresponding to a gas source connected to the flue gas processing system;
based on the received parameter signal, determining that the parameter corresponding to the gas source is above a parameter-threshold level; and
based on the determination that the parameter is above the parameter-threshold level, causing the at least one fan to transition from operating at the first fan speed to operating at a second fan speed, wherein the second fan speed is greater than the first fan speed.

20. The method of claim 19, further comprising:
while the at least one fan is operating at the second fan speed, receive, via a second sensor, a humidity signal indicating a humidity level corresponding to a reaction chamber of the flue gas processing system;
based on the received humidity signal, determine that the humidity level corresponding to the reaction chamber is above a humidity-threshold level; and
based on the determination that the humidity level is above the humidity-threshold level, causing the at least one fan to transition from operating at the second fan speed to operating at a third fan speed, wherein the third fan speed is greater than the second fan speed.
